(19) United States
(12) Patent Application Publication
(10) Pub. No.: US 2006/0188208 A1
(43) Pub. Date: Aug. 24, 2006

(54) Optical connector field termination oven and kit

(75) Inventor: John Carberry, Talbott, TN (US)

Correspondence Address: PITTS AND BRITTIAN P C, P O BOX 51295, KNOXVILLE, TN, 37950-1295, US

(73) Assignee: Neptec Optical Solutions, Inc., Jefferson City, TN (US)

(21) Appl. No.: 11/064,311

(22) Filed: Feb. 23, 2005

(51) Int. Cl. G02B 6/00

(52) U.S. Cl. 385/134

(57) ABSTRACT

An apparatus for a termination oven for attaching optical connectors to fiber optic cables in the field. The termination oven includes an oven with a heater and a temperature sensor. A controller manages power applied to the heater. The termination oven includes a portable power supply and has provision for both an external ac power supply and an external dc power supply. A fiber optic cable has its fiber epoxied to a connector ferrule and the epoxy is cured in a curing oven.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a field termination kit for assembling optical connectors in the field. More particularly, this invention pertains to a portable oven suitable for curing the epoxy required to add an optical connector to a fiber optic cable.

2. Description of the Related Art

Optical fibers are commonly used for the transmission of all types of data, including telecommunications, video, and computer data. Unlike copper cables which use mechanical connections to terminate to equipment, fiber optic cables rely upon optical connectors for termination. Fiber optic connectors are commonly available in various sizes and configurations. Commercially available connector types include SC, LC, FC, ST, MT-RJ, SMA, MU, LX.5, and E2000.

An optical connector consists of a ferrule, through which the optical fiber is fed. The ferrule and fiber combination is polished to a precise endface geometry. The ferrule and fiber endface is butted to another fiber optic cable's ferrule and fiber endface, bringing the fiber endfaces into precise physical contact. In order to minimize signal loss, the fiber and ferrule endfaces must have a very smooth and clean surface.

Like electrical connectors, it is oftentimes necessary to terminate fiber optic cables in the field. However, unlike electrical connections, fiber optic connections are more complex to make in the field. Traditionally, there have been two methods for connectorizing the end of a fiber, both of which meet industry standards. The industry standards are those promulgated by Telcordia, TIA, IEEC, IEA, among others. The first method is a mechanical splice that uses a ceramic ferrule, machined to very precise nanometer and micron tolerances for diameter, concentricity, and endface geometry. The fiber is fixed in the ferrule with epoxy. The ferrule and fiber are then assembled into a connector that is mated to another connector. The second method is fusion splicing that joins two fibers together by fusing, or welding, two fibers together.

There is a need for a portable means for making field connections to fiber optic cables. Such field connections must be able to be made in areas with no outside power and in less then desirable conditions. Telcordia, the successor to Bellcore, has defined a General Requirement for such a capability, namely, GR-1081-CORE, which is built upon and incorporates GR-326-CORE. GR-1081-CORE identifies various requirements, including a self-contained kit capable of performing 50 terminations in less than 10 minutes per connector while meeting GR-326-CORE, the connections can be made without resort to an ac power source, and the tools and equipment to make the connections must be transportable and weigh less than a certain amount.

### BRIEF SUMMARY OF THE INVENTION

According to one embodiment of the present invention, a field termination oven for assembling optical connectors in the field is provided. The apparatus includes a portable oven suitable for curing the epoxy required to add an optical connector to a fiber optic cable. The oven is included in a portable case along with a dc power supply (a battery) and an oven controller.

Other embodiments provide for charging the battery and powering the termination oven with ac power.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of the outside of the termination oven kit;

FIG. 2 is a top plan view of one embodiment of the operating panel;

FIG. 3 is a view of a fiber optic cable and ferrule;

FIG. 4 is a flow diagram of one embodiment of the steps for making a connection to a fiber optic cable;

FIG. 5 is a block diagram of one embodiment of the circuit of the termination oven; and

FIG. 6 is a perspective view of one embodiment of a curing oven.

### DETAILED DESCRIPTION OF THE INVENTION

An apparatus for assembling optical connectors in the field is disclosed. The termination oven 100 is a portable means for adding a connector to the end of a fiber optic cable.

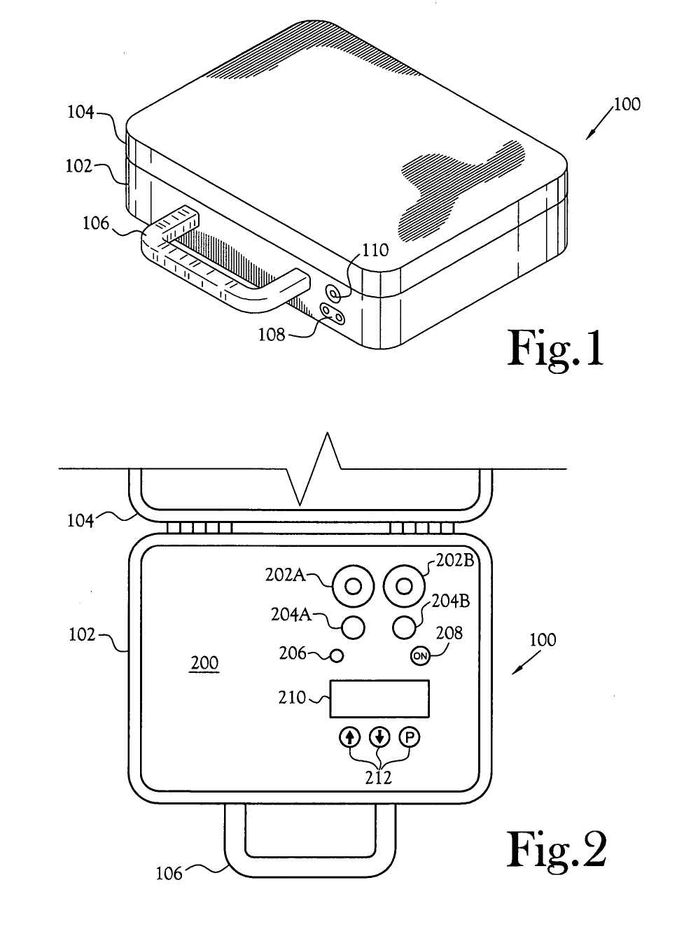

FIG. 1 illustrates a perspective view of one embodiment of the outside of the termination oven 100. The termination oven 100, in the illustrated embodiment, includes a portable case 102 with a cover 104 and a carrying handle 106. Also accessible from the outside of the case 102 is a connector 108 for alternating current (ac) power and a connector 110 for direct current (dc) power. Those skilled in the art will recognize that the ac power connector 108 and the dc power connector 110 can be located in various positions and/or locations on the termination oven 100.

FIG. 2 illustrates a top plan view of one embodiment of the operating panel 200 inside the case 102 of the termination oven 100. The illustrated embodiment includes two ovens 202A, 202B with their associated start/stop switches 204A, 204B. The operating panel 200 also includes a charging indicator lamp 206 and a main power switch 208. A controller display 210 and controller switches 212 provide the user interface to a controller 512.

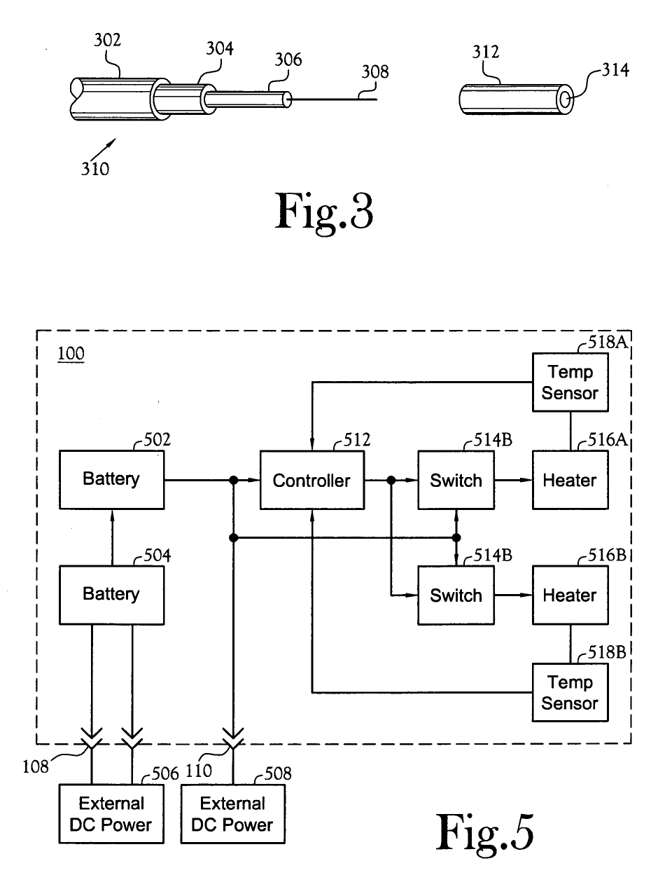

FIG. 3 illustrates a view of a simplex type fiber optic cable 310. This type of cable 310 has an outer protective jacket 302. Inside the jacket 302 is a strength member 304. Typically, the strength member 304 is formed of multiple aramid fibers, such as Kevlar. The strength member 304 surrounds a buffer 306 surrounding the fiber 308. Other types of fiber optic cables include distribution cables, loose tube cables, and breakout cables.

In line with the fiber 308 is a ferrule 312, which is a part of a connector. The ferrule 312 has an axial hole 314 sized to receive the fiber 308. The end of the ferrule 312 opposite the cable 310 is polished to provide a mating surface with another ferrule 312. In various embodiments, the ferrule 312 is either held captive in the connector or is loose and inserted into the connecter during assembly.

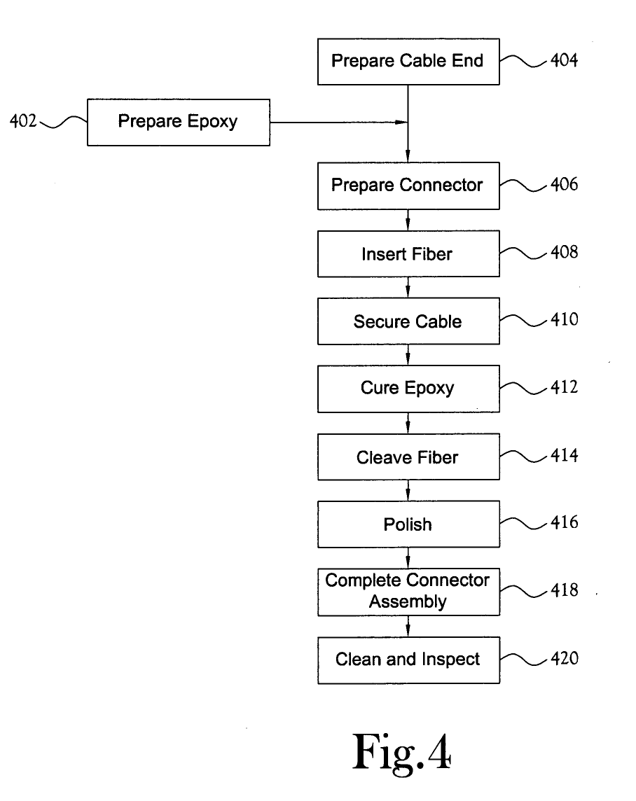

FIG. 4 illustrates a flow diagram of one embodiment of the steps for making a connection to a fiber optic cable 310 using the termination oven 100. The illustrated method is used to attach a fiber optic connector to the end of a fiber optic cable 410. It is contemplated that such a method would be useful for a technician in the field where factory-grade equipment is not available for making connections to cable 410.

The first steps are to prepare the epoxy 402 and to prepare the cable end 404. The epoxy is used to fix the fiber 308 in a ferrule 312, with the fiber 308 extending slightly beyond the end of the ferrule 312. In one embodiment, the epoxy is a two part compound that is heat cured. Preparation of the cable end 404, in one embodiment, includes stripping the jacket 302, trimming the strength member 404, and removing the buffer 306 to expose the fiber 308. The cable 310 is stripped to dimensions required by the specific connector to be attached to the cable 310. Those skilled in the art will recognize that the step of preparing the cable end 404 will vary depending upon the type of cable 410 and the type of connector to be attached without departing from the scope and spirit of the invention. In another embodiment, the step of preparing the cable end 404 includes placing on the cable any boot and crimp ring required for the type of connector to be attached.

The next step is to prepare the connector 406, which includes placing the prepared epoxy in the connector such that the epoxy fills the ferrule 312. In one embodiment, the epoxy exiting the end of the ferrule 312 is removed. In one embodiment, the epoxy is injected into the connector with a syringe.

After preparing the connector 406, the next step is to insert the fiber 408 into the connector until it protrudes from the opposite end of the ferrule 312. The fiber 308 is inserted into the connector until the buffer 306 butts up against the ferrule 312. The fiber 308 is rotated within the ferrule 312 to ensure the even spread of the epoxy. The next step is to secure the fiber optic cable 410 to the connector. In various embodiments, this step includes crimping the connector to the cable 310.

After the cable 310 is secured to the connector, the next step is to cure the epoxy 412. The termination oven 100 is energized and the temperature of one of the curing ovens 202 is monitored until it indicates that a temperature of 150° Celsius has been reached, at which time the connector is inserted into the curing oven 202 for 3½ minutes. In one embodiment, the termination oven 100 includes a countdown timer that is set for the desired time and actuated when the connector is inserted into the curing oven 202. The connector is removed from the curing oven 202 after the cure time has expired.

After the connector cools to the point where it can be handled comfortably, the next step is to cleave the fiber 414. The portion of the fiber 308 extending past the ferrule 312 and epoxy bead must be cleaved at the epoxy bead. In one embodiment, the fiber 308 is scored with a scribe in two places. The fiber 308 breaks when it is pulled away from the ferrule 312.

The next step is to polish 416 the fiber 308 and ferrule 312. In one embodiment, the connector is held with the cleaved end of the fiber 308 against an air polish film to remove the glass nub from cleaving. Then the connecter is attached to a puck that exposes the end of the ferrule 312, which is then moved across a series of progressively finer grit polishing films. First the epoxy bead is polished off and then the end of the ferrule 312 and the fiber 308 are polished to a flat, smooth surface. During this phase of polishing, the puck is moved over the film in a predetermined pattern for a specified number of rotations. During polishing, the fiber 308 and ferrule 312 are inspected to determine if the polishing is proceeding as necessary.

After polishing is completed, the next step is to complete the connector assembly 418. This step 418 includes inserting the connector into a housing and sliding the connector boot over the connector, if it has not already been done. The next step is to clean and inspect the connector 420. The connector end is cleaned by wiping the end of the connector across a cleaning material. A visual inspection is made of the end of the ferrule 312 and fiber 308 to ensure that the surface is properly prepared for mating with another connector. In one embodiment, a microscope is used to do the visual inspection.

FIG. 5 illustrates a block diagram of one embodiment of the circuit of the termination oven 100. In the portable configuration, power is supplied by a battery 502, which is a portable power supply. In one embodiment, the battery 502 is a lead-acid gel battery. The battery 502 is connected, through an ac power connector 108, to a charger and power supply 504 that is energized when an external ac power supply 506 is connected to the termination oven 100. In one embodiment, the charger and power supply 504 operates a charging indicator lamp 206 located on the operating panel 200.

An external dc power supply 508 is connected to the battery 502 through a dc power connector 110. The external dc power supply 508, in various embodiments, include an ac powered power supply, such as those commonly known as wall warts, and another battery, such as one in a motor vehicle. In the various modes of operation, the battery 502, the external ac power supply 506, and/or the external dc power supply 508 supply power to the other components in the termination oven 100.

The controller 512 provides control signals to a switch 514 that controls the power supplied to the oven heater 516. A temperature sensor 518 monitors the temperature of the curing oven 202 and provides a signal to the controller 512. In the illustrated embodiment, there are two curing ovens 202A, 202B with two oven heaters 516A, 516B, two switches 514A, 514B, and two temperature sensors 518A, 518B. Those skilled in the art will recognize that the number of ovens can vary without departing from the spirit and scope of the present invention. In various embodiments, the temperature sensor 518 is a thermocouple, a thermistor, or any other device that senses temperature.

The controller 512 includes a controller display 210 and one or more controller switches 212 that provide the user interface to the controller 512. The controller 512 manages the energy usage of the termination oven 100 to maximize the number of connectors that can be cured with the termination oven 100 when operating on the battery 502 without external power 506, 508. In one embodiment, the controller 512 ramps the temperature of the curing oven 202 sensed by the temperature sensor 518 until the desired operating temperature is reached. Then the controller 512 ensures that the desired operating temperature is maintained during the curing cycle. After the curing cycle is over, the controller 512 removes power to the oven heater 516.

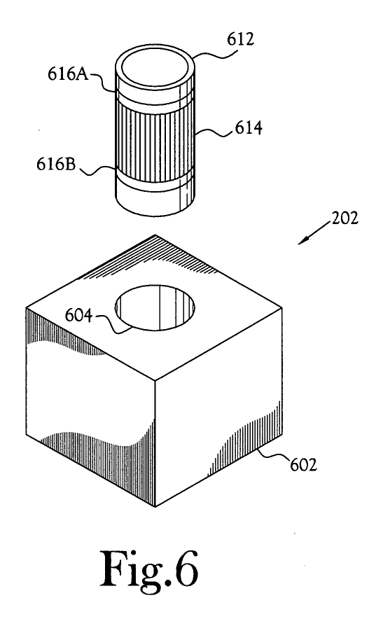

FIG. 6 illustrates a perspective view of one embodiment of a curing oven 202. In one embodiment, the curing oven 202 is a block 602 of formed silica surrounding a milled alumina chamber 612. The chamber 612 is a in the shape of a cylindrical tube that fits into an opening 604 in the block 602. The chamber 612, in one embodiment, is coated first with silver 616 and then a graphite overcoat 614 until a selected resistance is attained. The silver 616 and graphite 614 coatings are then coated with a sealant. The graphite coating 614 is a resistance heater that heats the chamber 612.

In one embodiment, clips around the chamber 602 and in contact with the silver coatings 616A, 616B at each end of the graphite coating 614 provide the electrical connection to the curing oven 202. Applying a voltage across chamber 612 causes the chamber 612 to quickly heat up. The formed silica 602 insulates the chamber 612. In one embodiment, the curing oven 202 has an cover for the opening into the chamber 612 whereby the cover traps the heat inside the chamber 612 and minimizes heat loss.

The termination oven 100 includes various functions. The function of curing an epoxy securing a optical fiber end 308 to a portion of a fiber optic connector is implemented, in one embodiment, by a curing oven 202 powered by a portable power supply 502 that is connected to the curing oven heater 516 through a switch 514 controlled by a controller 512, as illustrated in FIG. 5.

From the foregoing description, it will be recognized by those skilled in the art that an apparatus and method for making field terminations to fiber optic cables has been provided. The apparatus includes a termination oven 100 that includes a curing oven 202 with a heater 516 and a temperature sensor 518. A controller 512 controls the termination oven 100 and manages energy usage from a portable power supply 502. The termination oven 100 is a self-contained unit that weighs no more than forty pounds and can be easily carried.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. An apparatus for terminating a fiber optic cable, said apparatus comprising:
an oven adapted to receive an optical fiber end inserted into a portion of a fiber optic connector;
a heater for heating said oven to a selected temperature;
a temperature sensor associated with said oven, said temperature sensor monitoring a temperature of said oven;
a portable power supply providing power to said heater;
a charger for said portable power supply, said charger having a connection for an external power supply;
a switch electrically connected to said portable power supply and said heater, said switch selectively connecting said portable power supply to said heater; and
a controller receiving an input from said temperature sensor and providing an output to said switch for operating said switch;
wherein said oven, said heater, said temperature sensor, said portable power supply, and said switch are housed in a single case having a total weight of no more than forty pounds, whereby said controller manages the energy usage of said heater, and said oven cures at least fifty fiber optic connectors without recharging said portable power supply and operated solely from said portable power supply.

2. The apparatus of claim 1 wherein said selected temperature is at least 150 degrees Celsius.

3. The apparatus of claim 1 wherein said selected temperature is sufficient to cure an epoxy fixing said optical fiber to said portion of said fiber optic connector.

4. The apparatus of claim 1 further including a kit to polish a cured connector end, said kit including at least one puck for holding said connector end and at least one polishing film.

5. The apparatus of claim 1 further including a kit to clean a cured connector end.

6. The apparatus of claim 1 wherein said oven includes an insulating block and a heating chamber, said insulating block receiving said heating chamber.

7. The apparatus of claim 1 wherein said oven includes an insulating block and a heating chamber, said insulating block receiving said heating chamber, said heater includes a resistance coating on said heating chamber for heating the chamber when a voltage is applied across said resistance coating.

8. An apparatus for terminating a fiber optic cable, said apparatus comprising:
a case;
a portable power supply; and
a means for curing an epoxy securing an optical fiber end to a portion of a fiber optic connector;
wherein said portable power supply and said means for curing are contained in said case.

9. An apparatus for terminating a fiber optic cable, said apparatus comprising:
an oven adapted to receive an optical fiber end inserted into a portion of a fiber optic connector;
a heater for heating said oven to a selected temperature;
a temperature sensor associated with said oven, said temperature sensor monitoring a temperature of said oven;
a portable power supply providing power to said heater;
a switch electrically connected to said portable power supply and said heater, said switch selectively connecting said portable power supply to said heater; and
a controller receiving an input from said temperature sensor and providing an output to said switch for operating said switch;
wherein said oven, said heater, said temperature sensor, said portable power supply, and said switch are housed in a single case and having a total weight of no more than forty pounds, whereby said controller manages the energy usage of said heater, and said oven cures at least fifty fiber optic connectors without recharging said portable power supply.

10. The apparatus of claim 9 wherein said single case further includes a battery charger for said portable power supply.

11. The apparatus of claim 9 wherein said single case further includes a connection to an external power supply.

12. The apparatus of claim 9 wherein said selected temperature is at least 150 degrees Celsius.

13. The apparatus of claim 9 wherein said selected temperature is sufficient to cure an epoxy fixing said optical fiber to said portion of said fiber optic connector.

14. The apparatus of claim 9 further including a kit to polish a cured connector end, said kit including at least one puck for holding said connector end and at least one polishing film.

15. The apparatus of claim 9 further including a kit to clean a cured connector end.

16. The apparatus of claim 9 wherein said oven includes an insulating block and a heating chamber, said insulating block receiving said heating chamber.

17. The apparatus of claim 9 wherein said oven includes an insulating block and a heating chamber, said insulating block receiving said heating chamber, said insulting block formed of silica and said heating chamber formed of alumina.

18. The apparatus of claim 9 wherein said oven includes an insulating block and a heating chamber, said insulating block receiving said heating chamber, said heater includes a resistance coating on said heating chamber for heating the chamber when a voltage is applied across said resistance coating.
